(19) United States
(12) Patent Application Publication
(10) Pub. No.: US 2017/0196055 A1
(43) Pub. Date: Jul. 6, 2017

(54) LIGHT EMITTING DEVICE DRIVER CIRCUIT AND DRIVING METHOD OF LIGHT EMITTING DEVICE CIRCUIT

(71) Applicant: RICHTEK TECHNOLOGY CORPORATION, Zhubei City (TW)

(72) Inventors: Tong-Cheng Jao, Taichung (TW); Isaac Y. Chen, Zhubei City (TW); Yi-Wei Lee, Taipei (TW); Wei-Ming Chiu, Zhubei City (TW); Jiun-Hung Pan, Taipei (TW)

(21) Appl. No.: 15/216,890

(22) Filed: Jul. 22, 2016

(30) Foreign Application Priority Data
Jan. 5, 2016 (TW) 105100120

(51) Int. Cl. H05B 33/08; H05B 37/02

(52) U.S. Cl. CPC H05B 33/0815; H05B 37/0281; H05B 33/083; H05B 33/0842

(57) ABSTRACT

A light emitting device circuit has one or plural light emitting devices connected in series. A light emitting device driver circuit drives the light emitting device circuit according to a rectified input voltage. The light emitting device driver circuit includes a power switch and a control circuit. When the power switch is conductive, a light emitting device current flows through the light emitting device circuit and the power switch. When the power switch is not conductive, an output capacitor discharges to provide the light emitting device current. The control circuit determines whether the rectified input voltage is lower or not lower than a forward voltage plus a reference voltage according to a voltage at a reverse end of the light emitting device circuit, and control the power switch accordingly.

### CROSS REFERENCE

The present invention claims priority to TW 105100120, filed on Jan. 5, 2016.

### BACKGROUND OF THE INVENTION

Field of Invention

The present invention relates to a light emitting device driver circuit and a driving method of a light emitting device circuit; particularly, it relates to a high efficiency light emitting device driver circuit and a high efficiency driving method of a light emitting device circuit.

Description of Related Art

FIGS. 1A and 1B show schematic diagrams of a light emitting diode (LED) driver circuit and its related signal waveforms of US patent application No. US 2014/0246985, respectively. As shown in FIG. 1A, the LED driver circuit includes a power switch SM, an output capacitor Cout, a comparator 201, a feedback controller 202, and an AC input voltage detector 203. The power switch SM is coupled between one terminal of a rectified voltage Vbus and a forward terminal of an LED device. The output capacitor Cout is connected to the LED device in parallel. The AC input voltage detector 203 is directly connected to an AC power source, for receiving an AC voltage, to generate an absolute value Vab of the AC voltage. The feedback controller 202 receives an LED current sampling signal Isense and a reference voltage Vref2, and adjusts a reference voltage Vref1 accordingly. An inverted terminal of the comparator 201 is connected to the AC input voltage detector 203, for receiving the absolute value Vab of the AC voltage. A non-inverted terminal of the comparator 201 receives a sum of a forward voltage Vled and the reference voltage Vref1. The forward voltage Vled is a minimum voltage required for forward conducting the LED device. An output terminal of the comparator 201 is electrically connected to the power switch SM, for controlling a conductive status of the power switch SM.

FIG. 1B shows schematic diagrams of the signal waveforms of FIG. 1A. It is thus described in US 2014/0246985: “When absolute value Vab of AC input voltage is greater than the sum of forward voltage Vled and reference voltage Vref1, comparator 201 can be used to turn off power switch SM, and the LED driver may stop generating output current Iout. When absolute value Vab of AC input voltage is greater than forward voltage Vled, but less than the sum of forward voltage Vled and reference voltage Vref1, comparator 201 can be used to turn on power switch SM to generate output current Iout. During half of the switching cycle T/2, output current Iout can last for 2*t1.”

An advantage of the prior art LED driver circuit shown in FIG. 1A is that, when the absolute value Vab is higher than the sum of the forward voltage Vled and the reference voltage Vref1, the driving signal Vdrive generated by the comparator 201 does not turn ON the power switch SM, such that the power loss is reduced and the efficiency of the LED driver circuit is increased. However, the prior art LED driver circuit shown in FIG. 1A has a disadvantage that its manufacturing cost is high, because the major circuit components (including the comparator 201 and the feedback controller 202, etc.) of the prior art LED driver circuit need to directly receive high voltage, so these components need to use high voltage devices which are costly. To solve the aforementioned problem such that the LED driver circuit can operate in a relatively lower level, one possible solution is to set a ground level of the LED driver circuit to a floating level instead of an absolute 0V level, such as setting the ground level to the voltage level of the forward terminal of the LED device. However, this solution will cause another problem. Due to manufacturing variations, the forward voltages of different LED devices could be very different. Thus, when the ground level is floating, the ground level of the comparator 201 is not 0V, but the absolute value Vab of the AC voltage could be much lower than the floating level. The LED driver circuit, which is an integrated circuit, cannot sustain a high negative voltage. Therefore, this solution is not practicable.

In view of above, the present invention proposes a light emitting device driver circuit and a driving method of a light emitting device circuit with a high efficiency and a low manufacturing cost; the light emitting device driver circuit does not receive a high voltage directly.

### SUMMARY OF THE INVENTION

From one perspective, the present invention provides alight emitting device driver circuit configured to operably drive a light emitting device circuit which is operative according to a rectified input voltage, wherein the light emitting device circuit includes one light emitting device or a plurality of light emitting devices connected in series, wherein the light emitting device circuit has a forward terminal and a reverse terminal, and when a voltage between the forward terminal and the reverse terminal is not lower than a forward voltage, the light emitting device circuit is conductive, the light emitting device driver circuit comprising: a power switch, coupled to the light emitting device circuit and configured to be coupled to a first output capacitor, the power switch being configured to operate according to an operation signal, wherein the rectified input voltage has an original voltage level when the first output capacitor is not installed, and the rectified input voltage is adjusted to an adjusted voltage level when the first output capacitor is installed; and a control circuit, which is coupled to the reverse terminal and the power switch, and configured to operably determine whether or not the rectified input voltage is lower than a sum of the forward voltage plus a reference voltage according to a voltage of the reverse terminal, to generate the operation signal for keeping the power switch conductive when the rectified input voltage is lower than the sum; wherein when the power switch is conductive and the original voltage level is higher than a voltage across the first output capacitor, the first output capacitor is charged and a light emitting device current is provided to the light emitting device circuit.

In one preferable embodiment, the power switch is kept conductive in a period wherein the original voltage level is lower than the forward voltage.

In one preferable embodiment, when the power switch is not conductive, or when the power switch is conductive but the original voltage level is lower than the voltage across the first output capacitor, the first output capacitor discharges to provide the light emitting device current to the light emitting device circuit.

In one preferable embodiment, the forward terminal receives the rectified input voltage, and the control circuit includes: a current regulator circuit, which is coupled to the reverse terminal, and configured to operably regulate the light emitting device current; and a first comparison circuit, which is configured to operably generate the operation signal according to the reference voltage and a signal related to the voltage of the reverse terminal.

In one preferable embodiment, the signal related to the voltage of the reverse terminal is a divided voltage of the voltage of the reverse terminal.

In one preferable embodiment, the current regulator circuit includes: a current sense circuit, which is coupled to the reverse terminal, and configured to operably generate a current sense signal according to the light emitting device current; a divider circuit, configured to generate the signal related to the voltage of the reverse terminal; and a second comparison circuit, which is coupled to the current sense circuit and the divider circuit, wherein the second comparison circuit is configured to operably generate a regulation voltage for regulating the light emitting device current according to the current sense signal and the signal related to the voltage of the reverse terminal.

In one preferable embodiment, the light emitting device driver circuit further includes a capacitor circuit, which is coupled to an output terminal of the second comparison circuit, and configured to operably filter the regulation voltage.

In one preferable embodiment, the light emitting device driver circuit further includes a timer control circuit, wherein the power switch is conductive for two separate time periods including a first and a second conductive time periods in each period of the rectified input voltage, and the timer control circuit is configured to operably control the second conductive time period of the power switch according to the first conductive time period.

In one preferable embodiment, the forward terminal is coupled to a second output capacitor which is configured to operably improve a power factor of the light emitting device current, and the timer control circuit includes: a delay circuit, which is coupled to the output terminal of the first comparison circuit, and configured to operably delay a predetermined period according to the operation signal, to generate a setting signal; a flip-flop circuit, which is coupled to the delay circuit, and configured to operably generate a switch control signal according to the setting signal and the operation signal; and an overriding switch, which is coupled to the output terminal of the flip-flop circuit and an input terminal of the first comparison circuit, and configured to operably generate an overriding signal according to the switch control signal, to adjust a voltage of the input terminal of the first comparison circuit, for controlling the second conductive time period of the power switch in the period of the rectified input voltage.

In one preferable embodiment, the control circuit includes a phase sense circuit, which is coupled to the reverse terminal, and configured to operably sense a phase angle of the rectified input voltage, for controlling the conductive time of the power switch.

In one preferable embodiment, the power switch is coupled between the rectified input voltage and the forward terminal to receive the rectified input voltage, and the control circuit includes: a current regulator circuit, which is coupled to the reverse terminal, and configured to operably regulate the light emitting device current; a voltage divider circuit, which is connected to the rectified input voltage, and configured to operably generate a divided voltage as the operation signal; and a third comparison circuit, which is coupled to the reverse terminal and the divider circuit, and configured to operably control the divided voltage of the voltage divider circuit according to the voltage of the reverse terminal.

In one preferable embodiment, the power switch is coupled between the current regulator circuit and a ground level, and an output of the first comparison circuit controls a bipolar junction transistor (BJT) to generate a current flowing through a resistor, and the operation signal is generated according to a voltage across the resistor.

In one preferable embodiment, the power switch is coupled between the current regulator circuit and a ground level, and the first comparison circuit receives a positive operation power source from the reverse terminal.

In one preferable embodiment, the driver circuit further includes a MOS device, which is coupled between the positive operation power source of the first comparison circuit and the reverse terminal.

In one preferable embodiment, the control circuit includes: a level determination circuit, which is configured to operably sense a level of the rectified input voltage; a peak determination circuit, which is configured to operably receive a sense result of sensing the light emitting device current, to determine a peak value of the light emitting device current; and a switching timing control circuit, which is coupled to the level determination circuit and the peak determination circuit, and configured to operably determine a timing point of turning ON the power switch according to an output of the level determination circuit, and determine a timing point of turning OFF the power switch according to an output of the peak determination circuit.

In one preferable embodiment, the level determination circuit includes a valley detection circuit, configured to operably detect a valley of the rectified input voltage.

In one preferable embodiment, the level determination circuit includes a voltage divider circuit, configured to operably obtain a divided voltage of the rectified input voltage or a divided voltage of a signal related to the rectified input voltage.

From another perspective, the present invention provides a light emitting device driver circuit configured to operably drive a light emitting device circuit which is operative according to a rectified input voltage, wherein the light emitting device circuit includes one light emitting device or a plurality of light emitting devices connected in series, wherein the light emitting device circuit has a forward terminal and a reverse terminal, and when a voltage between the forward terminal and the reverse terminal is not lower than a forward voltage, the light emitting device circuit is conductive, the light emitting device driver circuit comprising: a power switch, coupled to the light emitting device circuit and configured to be coupled to an output capacitor, the power switch being configured to operate according to an operation signal, to charge the output capacitor during at least a part of a time period wherein the power switch is conductive, and to conduct a light emitting device current flowing through the light emitting device circuit and the power switch when a voltage between the forward terminal and the reverse terminal is not lower than the forward voltage; and a control circuit, which is coupled to the power switch, and includes: a level determination circuit, which is configured to operably sense a level of the rectified input voltage; a peak determination circuit, which is configured to operably receive a sense result of sensing the light emitting device current, and determine a peak value of the light emitting device current; and a switching timing control circuit, which is coupled to the level determination circuit and the peak determination circuit, and configured to operably determine a timing point of turning ON the power switch according to an output of the level determination circuit, and determine a timing point of turning OFF the power switch according to an output of the peak determination circuit; wherein transistor devices of the peak determination circuit and the switching timing control circuit are low voltage devices which operate between a high operation voltage and a low operation voltage, and a difference between the high operation voltage and the low operation voltage is equal to or smaller than one half of a highest voltage at the forward terminal.

In one preferable embodiment, the peak determination circuit includes: a current sense circuit, which is coupled to the power switch, and configured to operably generate a sense signal according to a switch current flowing through the power switch; and a comparison circuit, which is coupled to the current sense circuit, and configured to operably generate a comparison signal according to the sense signal and a reference signal.

In one preferable embodiment, the driver circuit further includes a slew rate adjustment circuit, which is coupled to the power switch, and configured to operably receive the operation signal and adjust a slew rate of the operation signal, to generate a slew rate adjusted operation signal having a slower slew rate than the operation signal, for operating the power switch.

In one preferable embodiment, the power switch includes a vertical double diffused metal oxide semiconductor (VDMOS) device.

From another perspective, the present invention provides a driving method of a light emitting device circuit, wherein the light emitting device circuit includes one light emitting device or a plurality of light emitting devices connected in series, wherein the light emitting device circuit has a forward terminal and a reverse terminal, and when a voltage between the forward terminal and the reverse terminal is not lower than a forward voltage, the light emitting device circuit is conductive, the driving method comprising: receiving a rectified input voltage; controlling a power switch according to an operation signal, such that during at least a part of a time period wherein the power switch is conductive, an output capacitor is charged, and a light emitting device current flows through the light emitting device circuit and the power switch when a voltage between the forward terminal and the reverse terminal is not lower than the forward voltage, and when the power switch is not conductive, the output capacitor discharges to provide the light emitting device current to the light emitting device circuit; and determining whether or not the rectified input voltage is lower than a sum of the forward voltage plus a reference voltage according to a voltage of the reverse terminal, and generating the operation signal accordingly, for keeping the power switch conductive when the rectified input voltage is lower than the sum, and keeping the power switch not conductive when the rectified input voltage is higher than the sum.

From another perspective, the present invention provides a driving method of a light emitting device circuit, wherein the light emitting device circuit includes one light emitting device or a plurality of light emitting devices connected in series, wherein the light emitting device circuit has a forward terminal and a reverse terminal, and when a voltage between the forward terminal and the reverse terminal is not lower than a forward voltage, the light emitting device circuit is conductive, the driving method comprising: providing a rectified input voltage to the forward terminal; controlling a power switch according to an operation signal, such that during at least a part of a time period wherein the power switch is conductive, an output capacitor is charged, and a light emitting device current flows through the light emitting device circuit and the power switch when a voltage between the forward terminal and the reverse terminal is not lower than the forward voltage, and when the power switch is not conductive, the output capacitor discharges to provide the light emitting device current to the light emitting device circuit; sensing a level of the rectified input voltage; sensing the light emitting device current; determining a peak value of the light emitting device current; and determining a timing point of turning ON the power switch according to the level of the rectified input voltage, and determining a timing point of turning OFF the power switch according to peak value of the light emitting device current; wherein the steps of: sensing the light emitting device current; receiving a sense result of sensing the light emitting device current, and determining a peak value of the light emitting device current; and determining a timing point of turning ON the power switch according to the level of the rectified input voltage, and determining a timing point of turning OFF the power switch according to peak value of the light emitting device current, are achieved by circuits whose transistor devices are made of low voltage devices which operate between a high operation voltage and a low operation voltage, and a difference between the high operation voltage and the low operation voltage is equal to or smaller than one half of a highest voltage at the forward terminal.

The objectives, technical details, features, and effects of the present invention will be better understood with regard to the detailed description of the embodiments below.

### BRIEF DESCRIPTION OF THE DRAWINGS

FIG. 1A shows a schematic diagram of a prior art light emitting diode (LED) driver circuit and its related circuits.

FIG. 1B shows a schematic diagram of the signal waveforms of the prior art LED driver circuit and its related circuits.

FIGS. 2A and 2B show a first embodiment of the present invention and its related signal waveforms.

FIG. 3A shows a second embodiment of the present invention.

FIG. 3B shows a specific embodiment of the second embodiment of the present invention.

FIGS. 4A and 4B show a third embodiment of the present invention and its related signal waveforms.

FIG. 4C shows a specific embodiment of the third embodiment of the present invention.

FIG. 5 shows a fourth embodiment of the present invention.

FIG. 6 shows a fifth embodiment of the present invention.

FIG. 7 shows a sixth embodiment of the present invention.

FIG. 8 shows a seventh embodiment of the present invention.

FIG. 9 shows an eighth embodiment of the present invention.

FIG. 10A shows a ninth embodiment of the present invention.

FIG. 10B shows a specific embodiment of the ninth embodiment of the present invention.

FIG. 10C shows another specific embodiment of the ninth embodiment of the present invention.

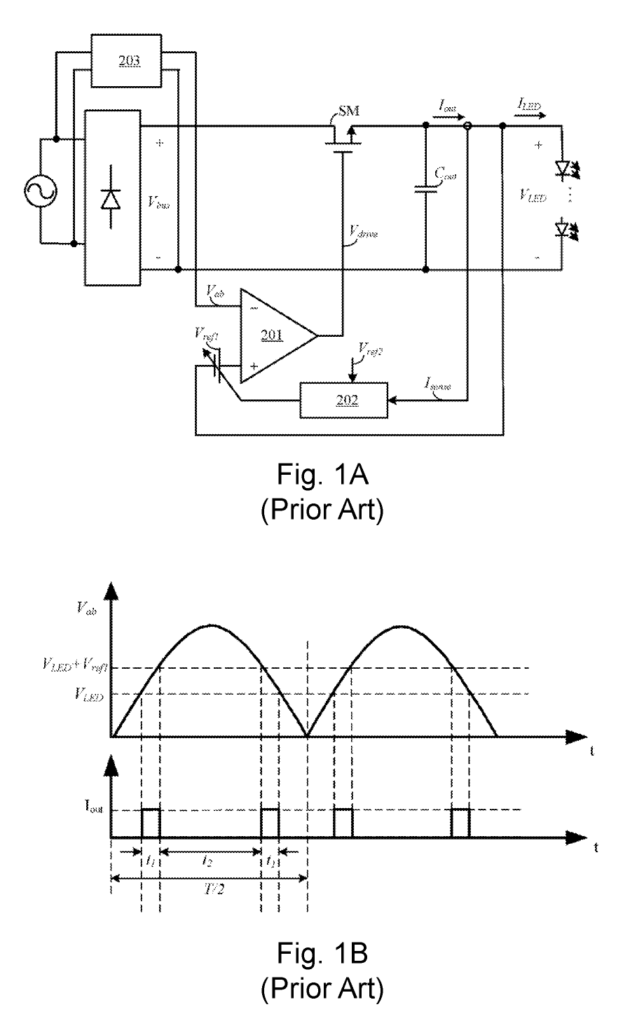

### DESCRIPTION OF THE PREFERRED EMBODIMENTS

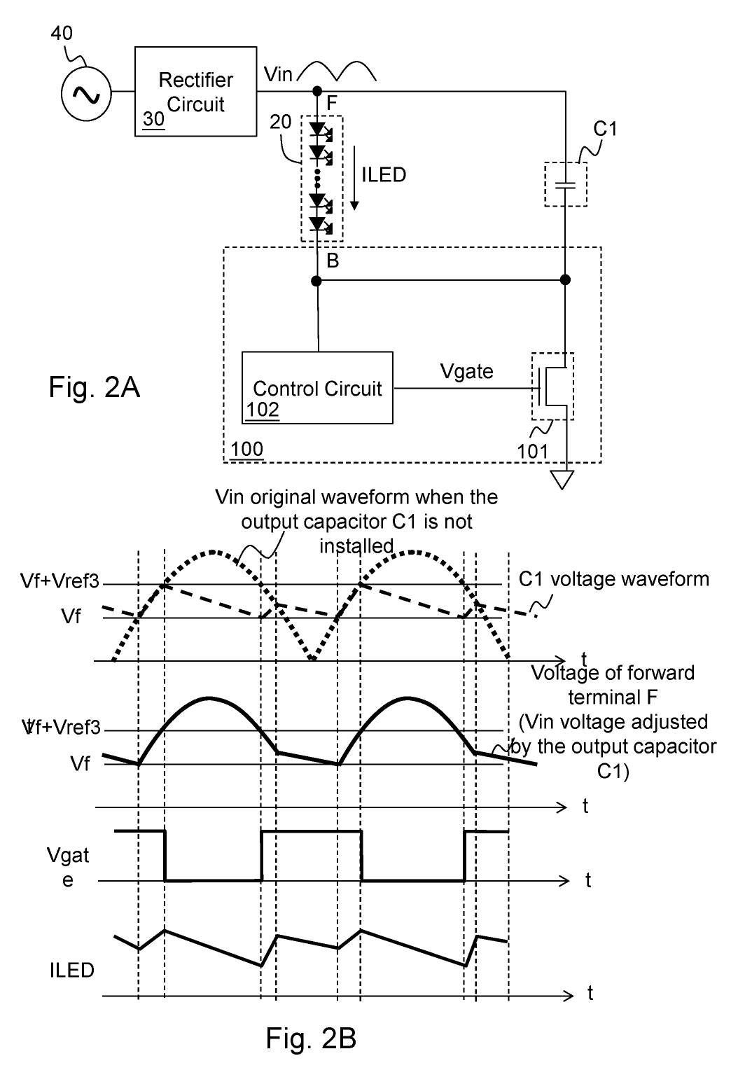

Please refer to FIGS. 2A and 2B for a first embodiment according to the present invention. As shown in FIG. 2A, a light emitting device driver circuit 100 drives a light emitting device circuit. The light emitting device circuit includes one light emitting device or plural light emitting devices connected in series. The light emitting device circuit for example is a light emitting diode (LED) circuit 20 as shown in the figure, which can includes one single LED string or an LED array consisting of plural LED strings connected in parallel, or a light emitting device string(s) or a light emitting device array in other forms. The rectifier circuit 30 receives an AC voltage generated by an AC power source 40, and rectifies the AC voltage to generate a rectified input voltage Vin, which, when not affected by an output capacitor C1 (when the output capacitor C1 is not installed so it does not exist in the circuit), has an original signal waveform which is indicated by a small signal waveform shown in the figure. The light emitting device driver circuit 100 drives the LED circuit 20 according to the rectified input voltage Vin, wherein the LED circuit 20 has a forward terminal F and a reverse terminal B; when a voltage between the forward terminal F and the reverse terminal B is not lower than a forward voltage Vf, the LED circuit 20 is conductive. The light emitting device driver circuit 100 includes a power switch 101 and a control circuit 102. The power switch 101 is coupled to the LED circuit 20 and the output capacitor C1, and operates according to an operation signal Vgate. When the power switch 101 is conductive and the original rectified input voltage Vin is higher than a voltage across the output capacitor C1, the output capacitor C1 is charged and a light emitting device current ILED is provided to the LED circuit 20, and, preferably but not necessarily, when the power switch 101 is not conductive, or when the power switch 101 is conductive and the original rectified input voltage Vin is lower than the voltage across the output capacitor C1, the output capacitor C1 discharges, to provide the light emitting device current ILED to the LED circuit 20, so as to increase the power utilization efficiency. The control circuit 102 is coupled to the reverse terminal B and the power switch 101, for determining whether or not the rectified input voltage Vin is lower than a sum of the forward voltage Vf plus a reference voltage Vref3 according to a voltage of the reverse terminal B, and generating the operation signal Vgate accordingly, to keep the power switch 101 conductive when the rectified input voltage Vin is lower than the sum.

Please refer to FIG. 2B. The control circuit 102 determines whether or not the rectified input voltage Vin is lower than a sum of the forward voltage Vf plus the reference voltage Vref3 according to the voltage of the reverse terminal B, and generates the operation signal Vgate accordingly. When the rectified input voltage is lower than the sum of the forward voltage Vf plus the reference voltage Vref3, the operation signal Vgate is kept at a light level (this is for the case wherein the power switch 101 is turned ON by the high level of the operation signal; if the power switch 101 is turned ON by a low level of the operation signal, the operation signal Vgate should correspondingly be reversed) so that the power switch 101 is conductive; when the rectified input voltage Vin is not lower than a sum of the forward voltage Vf plus the reference voltage Vref3, the operation signal Vgate is kept at a low level so that the power switch 101 is not conductive.

More specifically, the rectified input voltage Vin has an original voltage level as shown by a dotted half-sinusoidal waveform in FIG. 2B, when the output capacitor C1 is not installed. The voltage across the output capacitor C1 has a dashed waveform shown in FIG. 2B. The rectified input voltage Vin is adjusted by the installation of the output capacitor C1, to become the solid waveform shown by the second waveform in FIG. 2B, when the first output capacitor C1 is installed. The voltage at the forward terminal F is determined by a higher one of the original voltage level of the rectified input voltage Vin and the voltage across the output capacitor C1. When the power switch 101 is conductive and the original voltage level of the rectified input voltage Vin is higher than the voltage across the output capacitor C1, the output capacitor C1 is charged and the light emitting device current ILED is provided to the LED circuit 20 by the rectifier circuit 30. When the power switch 101 is not conductive, or when the power switch 101 is conductive but the original voltage level of the rectified input voltage Vin is lower than the voltage across the output capacitor C1, the output capacitor C1 discharges to provide the LED current ILED to the LED circuit 20.

This embodiment is different from the prior art LED driver circuit at least in two aspects as described below. First, in this embodiment, the control circuit 102 does not directly receive the rectified input voltage Vin, but receives the voltage at the reverse terminal B of the LED circuit 20. Therefore, the control circuit 102 can be manufactured by a low voltage device manufacturing process which is less costly than a high voltage device manufacturing process. The low voltage device for example is a 5V or 10V device (i.e., a device which operate between a high operation voltage of 5V or 10V, and a low operation voltage of an absolute ground level). Thus, the manufacturing cost of the present invention is lower than the prior art, and because the ground level is an absolute ground level (0V), it reduces the risk of damaging the circuitry. Second, in this embodiment, the output capacitor C1 is efficiently used to store energy; it discharges to provide the light emitting device current ILED to the LED circuit 20 when the power switch 101 is not conductive, which effectively saves power.

Note that the aforementioned term “low voltage device” is a relative term as opposed to a “high voltage device”. Therefore, in this invention, the term “low voltage” is defined by a relative definition: it is a voltage lower than one half of a highest voltage at the forward terminal F. That is, a low voltage device, as defined by the present invention, is a transistor device which operates between a high operation voltage and a low operation voltage, and a difference between the high operation voltage and the low operation voltage is equal to or smaller than one half of a highest voltage at the forward terminal F. When the low operation voltage is the absolute ground level, the high operation voltage is equal to or smaller than one half of a highest voltage at the forward terminal F.

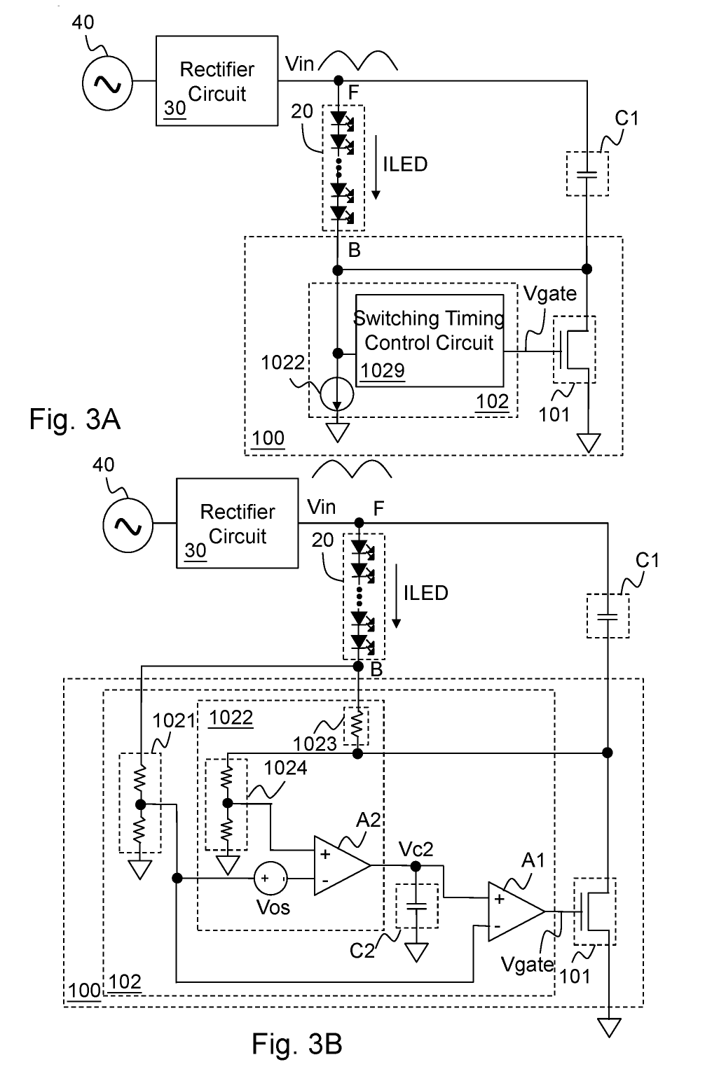

FIG. 3A shows a second embodiment of the present invention. In this embodiment, the control circuit includes: a current regulator circuit 1022 and a switching timing control circuit 1029. The current regulator circuit 1022 is configured to regulate the light emitting device current ILED to a target value. The switching timing control circuit 1029 determines whether or not the rectified input voltage Vin is lower than a sum of the forward voltage Vf plus the reference voltage Vref3 according to the voltage of the reverse terminal B, and generating the operation signal Vgate accordingly, to keep the power switch 101 conductive when the rectified input voltage Vin is lower than the sum of the forward voltage Vf plus the reference voltage Vref3. In one embodiment, the switching timing control circuit 1029 may be a comparison circuit, which compares the voltage of the reverse terminal B with a reference voltage (to be described in detail later) to determine whether or not to turn ON the power switch 101, so as to achieve the aforementioned control mechanism. Note that, “to compare the voltage of the reverse terminal B with a reference voltage” is not limited to comparing the voltage of the reverse terminal B itself with the reference voltage directly, but may be comparing a signal related to the voltage of the reverse terminal B (such as the voltage of the reverse terminal B itself or its divided voltage) with a signal related to the reference voltage (such as the reference voltage itself or its divided voltage). The aforementioned comparisons are equivalent.

The circuit structure shown in FIG. 3A may be embodied in various ways. FIG. 3B shows a more specific embodiment of the control circuit 102 shown in FIG. 3A. In this embodiment, the current regulator circuit 1022 is used not only for regulating the light emitting device current ILED, but also for generating the reference voltage; however, the present invention is not limited to this arrangement, and the reference voltage can be generated by other ways. More specifically, in this embodiment, the forward terminal F receives the rectified input voltage Vin, and the control circuit 102 includes: the current regulator circuit 1022 and a comparison circuit A1 (corresponding to the aforementioned the switching timing control circuit 1029, which is a comparator in this embodiment). Besides, optionally but not necessarily, the control circuit 102 may further include a voltage divider circuit 1021 and a filter circuit C2, wherein the voltage divider circuit 1021 can be omitted if the transistor devices in the control circuit 102 are capable of withstanding the voltage level of the reverse terminal B. The current regulator circuit 1022 is coupled to the reverse terminal B, for regulating the light emitting device current ILED. In this embodiment, the current regulator circuit 1022 includes a current sense circuit 1023, a voltage divider circuit 1024, and a comparison circuit A2 (such as an error amplifier shown in the figure of this embodiment). The current sense circuit 1023 is for example but not limited to a resistor shown in the figure, which is electrically connected to the reverse terminal B, wherein a voltage drop generated across the resistor by the light emitting device current ILED flowing through the resistor is taken as the current sense signal. By setting an offset voltage source Vos and selecting the resistances of the resistors, the current regulator circuit 1022 regulates the light emitting device current ILED to the target value by feedback control mechanism.

On the other hand, the comparison circuit A2 is coupled to the current sense circuit 1023 and the voltage divider circuit 1021, for generating a regulation voltage Vc2 according to the current sense signal and a divided voltage of the voltage of the reverse terminal B. The filter circuit C2 filters a high frequency signal of the regulation voltage Vc2 outputted from the comparison circuit A2, wherein the filter circuit C2 can be omitted if such a filter function is not necessary. The comparison circuit A1 compares the regulation voltage Vc2 with a divided voltage outputted from the divider circuit 1021, and operates the power switch 101 accordingly; that is, the comparison circuit A1 determines the status of the rectified input voltage Vin according to the voltage of the terminal B, such that when the rectified input voltage Vin is lower than the sum of the forward voltage Vf plus the reference voltage Vref3, the power switch 101 is conductive, and when the rectified input voltage Vin is not lower than the sum of the forward voltage Vf plus the reference voltage Vref3, the power switch is not conductive. Note that what the comparison circuit A1 is in direct contact is a low voltage regardless how many light emitting devices are in the light emitting device circuit 20 and regardless of the high voltage level of the forward terminal F, because the inverted input terminal of the comparison circuit A1 receives the divided voltage of the voltage of the reverse terminal B, and the voltage of the reverse terminal B is the rectified input voltage Vin minus the forward voltage Vf, which is low. And, the non-inverted input terminal receives the regulation voltage Vc2, which corresponds to the aforementioned reference voltage Vref3. This embodiment regulates an average value of the light emitting device current ILED to a target, and meanwhile controls the power switch 101 to be conductive and not conductive at proper timings.

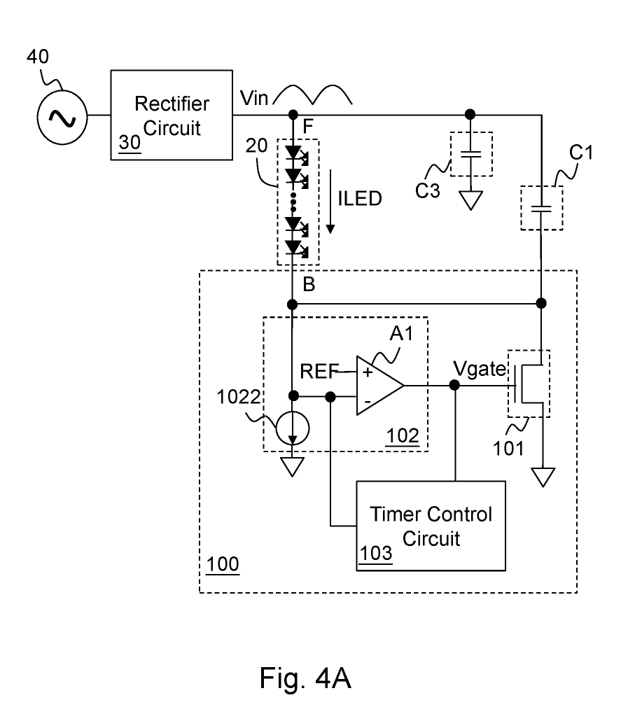

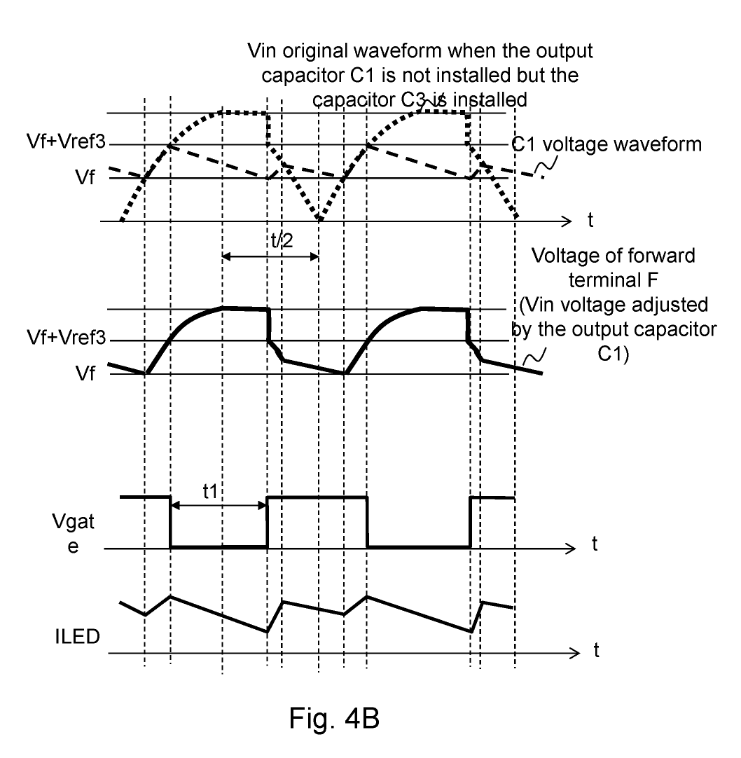

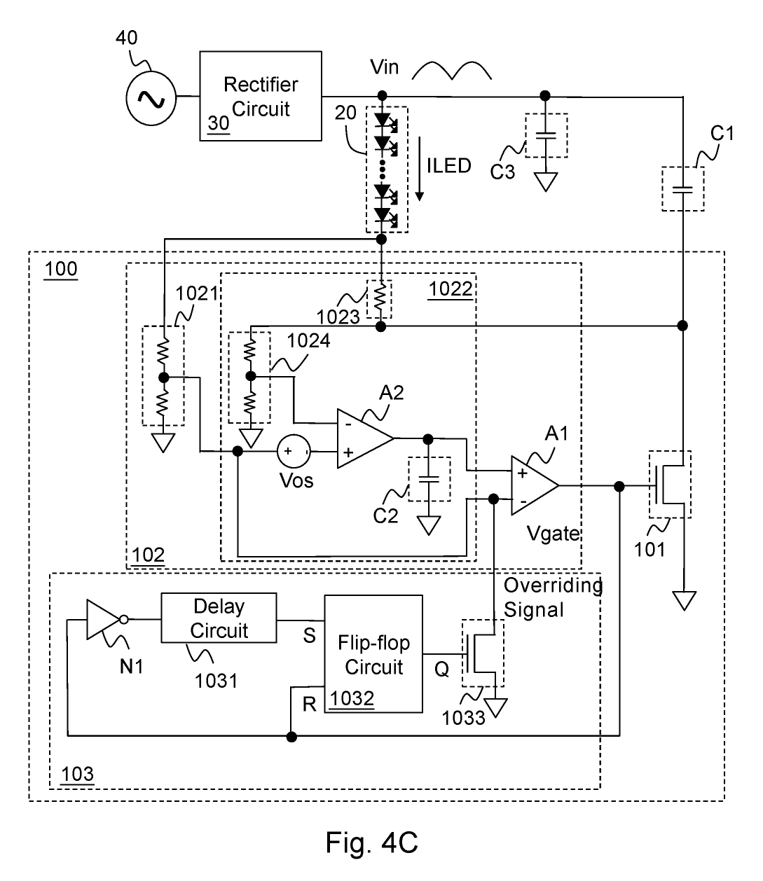

FIGS. 4A and 4B show a third embodiment of the present invention and related signal waveforms. This embodiment shows another embodiment of the light emitting device 100. As shown in FIG. 4A, in this embodiment, an output capacitor C3 is coupled to the forward terminal F, which is used to improve a power factor of the light emitting device current ILED, such that the power delivered by the rectifier circuit 30 is more efficiently utilized. However, because of the effect provided by the output capacitor C3, as shown in FIG. 4B, in a second half of each period of the rectified input voltage Vin (as shown by the half period t/2 indicated in FIG. 4B), the waveform of the rectified input voltage Vin will be kept at a relatively higher level rather than a semi-sinusoidal waveform. Therefore, the timing of turning ON the power switch 101 for the second time in the second half of the period cannot be determined according to the rectified input voltage Vin. To be more specific, if the rectified input voltage yin maintains the waveform of a semi-sinusoidal waveform, the timing of turning ON the power switch 101 can be determined according to a relationship between the rectified input voltage Vin and the sum of the forward voltage Vf plus the reference voltage Vref3; however, as the output capacitor C3 is installed, the timing of turning ON the power switch 101 cannot be determined according to such relationship between the rectified input voltage Vin and the sum of the forward voltage Vf plus the reference voltage Vref3.

To solve this, the light emitting device driver circuit 100 of this embodiment further includes a timer control circuit 103, which controls a second conductive time period of the power switch 101 according to a first conductive time period of the power switch 101 in each period of the rectified input voltage Vin. For example, after the operation signal Vgate turns OFF the power switch 101 in a first half period of the rectified input voltage Vin, the timer control circuit 103 counts a period t1, and the control circuit 102 turns ON the power switch 101 again. As such, the power switch 101 can be turned ON twice at correct timings in every period of the rectified input voltage Vin.

The circuit shown in FIG. 4A may be embodied in various ways. FIG. 4C for example shows a more specific embodiment of the timer control circuit 103. In this embodiment, the light emitting device driver circuit 100 further includes the timer control circuit 103, which has: an inverter N1, a delay circuit 1031, a flip-flop circuit 1032, and an overriding switch 1033. The inverter N1 is coupled to the comparison circuit A1, for receiving the operation signal Vgate to generate an inverse operation signal. The delay circuit 1031 is coupled to the inverter N1 and the output terminal of the comparison circuit A1, for delaying a predetermined period according to the operation signal Vgate, to generate a setting signal S (the length of this predetermined period should depend on the original period of the rectified input voltage Vin; the length is for example but not limited to 7 ms). The flip-flop circuit 1032 is coupled to the delay circuit 1031, for generating a switch control signal Q according to the setting signal S and the operation signal Vgate, wherein the operation signal Vgate for example can be used as a reset signal R of the flip-flop circuit 1032. The overriding switch 1033 is coupled to the output terminal of the flip-flop circuit 1032 and an input terminal of the comparison circuit A1, for generating an overriding signal according to the switch control signal Q. The overriding signal adjusts the voltage of the inverted input terminal of the comparison circuit A1, to thereby control the second conductive time period of the power switch 101 in each period of the rectified input voltage Vin. In this embodiment, when the switch control signal Q turns ON the overriding switch 1033, the voltage of the inverted input terminal of the comparison circuit A1 is pulled low, whereby the operation signal Vgate turns ON the power switch 101.

The above is only one among many possible methods to control the second conductive time period of the power switch 101. In light of the teachings by the present invention, there are many other methods to control the second conductive time period of the power switch 101. For example, if the delayed period t1 is counted from the turned-ON timing of the first conductive time period, the length of the delayed period should be different, and the inverter N1 can be omitted. For another example, if the overriding switch 1033 is a PMOS switch, the terminals of the flip-flop circuit 1032 should be connected by a different way. In view of the foregoing, the spirit of the present invention should cover all such and other modifications and variations, which should be interpreted to fall within the scope of the claims and their equivalents.

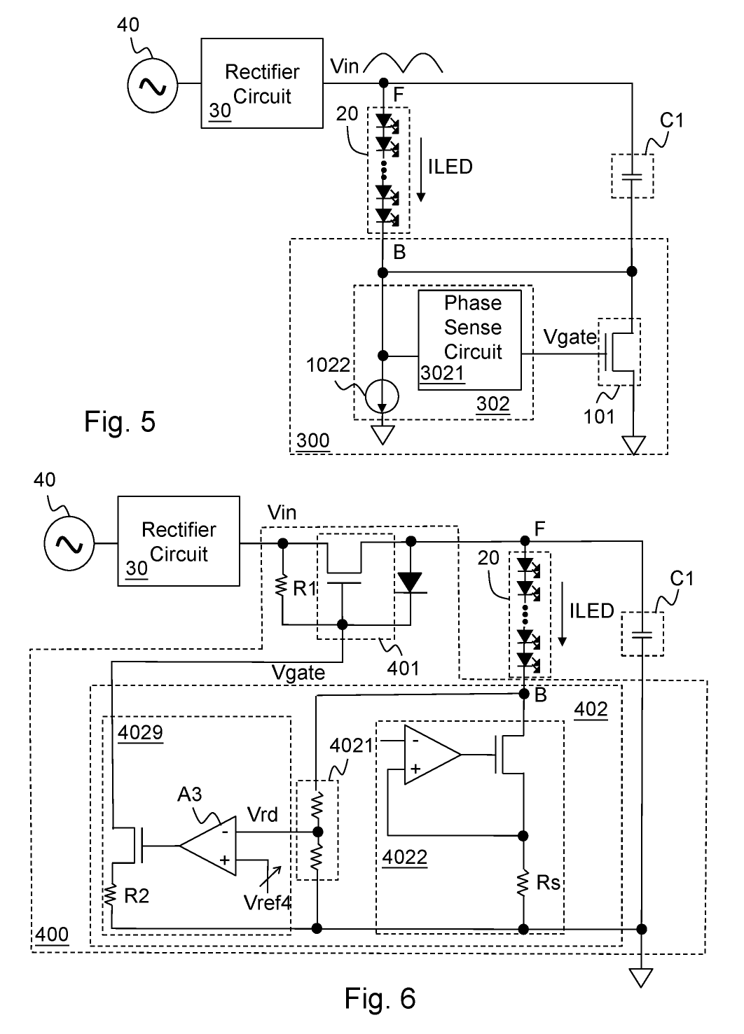

FIG. 5 shows a fourth embodiment of the present invention. This embodiment shows a light emitting device driver circuit 300 according to the present invention. In this embodiment, the light emitting device driver circuit 300 drives the LED circuit 20 according to the rectified input voltage Vin, wherein the LED circuit 20 has the forward terminal F and the reverse terminal B, and when a voltage between the forward terminal F and the reverse terminal B is not lower than the forward voltage Vf, the LED circuit 20 is conductive. The light emitting device driver circuit 300 includes the power switch 101 and the control circuit 302. The power switch 101 is coupled to the LED circuit 20 and the output capacitor C1, and operates according to the operation signal Vgate. When the power switch 101 is conductive and the original rectified input voltage Vin is higher than a voltage across the output capacitor C1, the output capacitor C1 is charged and the light emitting device current ILED is provided to the LED circuit 20; and, preferably but not necessarily, when the power switch 101 is not conductive, or when the power switch 101 is conductive but the original rectified input voltage Vin is lower than the voltage across the output capacitor C1, the output capacitor C1 discharges to provide the light emitting device current ILED to the LED circuit 20, so as to increase the power utilization efficiency.

The control circuit 302 includes the current regulator circuit 1022 for controlling the light emitting device current ILED, and a phase sense circuit 3021. The phase sense circuit 3021 is coupled to the reverse terminal B, for sensing a phase angle of the rectified input voltage Vin. For example, when the length of the period of the rectified input voltage Vin is known, the phase sense circuit 3021 can count the phase angle of the rectified input voltage Vin from a valley of the voltage of the reverse terminal B by a timer circuit. Thus, the control circuit 302 can determine the phase of the rectified input voltage Vin according to the voltage of the reverse terminal B, so as to determine whether or not the rectified input voltage Vin is lower than the sum of the forward voltage Vf plus the reference voltage Vref3, and generate the operation signal Vgate accordingly, such that the power switch 101 is conductive when the rectified input voltage Vin is lower than the sum of the forward voltage Vf plus the reference voltage Vref3.

By cross-referencing the embodiments shown in FIG. 5 and FIGS. 3A-3B, it can be found that there are various ways to embody the switching timing control circuit 1029; the comparison circuit A1 and the phase sense circuit 3021 are two examples.

FIG. 6 shows a fifth embodiment of the present invention. This embodiment shows a light emitting device driver circuit 400 according to the present invention. In this embodiment, the light emitting device driver circuit 400 drives the LED circuit 20 according to the rectified input voltage Vin, wherein the LED circuit 20 has the forward terminal F and the reverse terminal B, and when a voltage between the forward terminal F and the reverse terminal B is not lower than the forward voltage Vf, the LED circuit 20 is conductive. The light emitting device driver circuit 400 includes a power switch 401 and a control circuit 402. The power switch 401 is coupled to the LED circuit 20 and the output capacitor C1, and operates according to the operation signal Vgate. When the power switch 401 is conductive and the original rectified input voltage Vin is higher than a voltage across the output capacitor C1, the output capacitor C1 is being charged and the light emitting device current ILED is provided to the LED circuit 20; and, preferably but not necessarily, when the power switch 401 is not conductive, or when the power switch 401 is conductive but the original rectified input voltage Vin is lower than the voltage across the output capacitor C1, the output capacitor C1 discharges to provide the light emitting device current ILED to the LED circuit 20, so as to increase the power utilization efficiency. This embodiment is different from the aforementioned embodiments in that, the power switch 401 in this embodiment is coupled between the rectified input voltage Vin and the forward terminal F, and it receives the rectified input voltage Vin.

The control circuit 402 is coupled to the reverse terminal B and the power switch 401, for controlling the power switch 401 according to the voltage of the terminal B. In this embodiment, the control circuit 402 includes a current regulator 4022 and a switching timing control circuit 4029, and optionally further includes a voltage divider circuit 4021. The current regulator 4022 is coupled to the reverse terminal B, for regulating the light emitting device current ILED. The voltage divider circuit 4021 is for example but not limited to resistors connected in series as shown in the figure, which is electrically connected to the reverse terminal B, for generating a divided voltage Vrd according to the voltage of the reverse terminal B. The voltage divider circuit 4021 can be omitted if the voltage of the reverse terminal B is low enough that transistor devices in the control circuit 402 are capable of withstanding the voltage of the reverse terminal B. The switching timing control circuit 4029 is coupled to the voltage divider circuit 4021, for generating the operation signal Vgate according to the voltage of the reverse terminal B, such that, when the rectified input voltage Vin is lower than the sum of the forward voltage Vf plus the reference voltage Vref3, the power switch 401 is conductive.

In this embodiment, the switching timing control circuit 4029 includes a comparison circuit A3 (which can be a comparator or an operational amplifier in this embodiment), which compares the voltage of the reverse terminal B or its related signal with a reference voltage Vref4, to determine the operation signal Vgate. The reference voltage Vref4 may be a constant value or a variable value adjustable between at least two numbers for different applications.

Furthermore, as shown in the figure, in this embodiment, the comparison circuit A3 determines the operation signal Vgate by controlling a divided voltage at a node between resistors R1 and R2; the divided voltage is the operation signal Vgate. By this arrangement, although the power switch 401 is required to be a high voltage device because it receives the rectified input voltage Vin, the transistor devices in the control circuit 402 can be low voltage devices instead of high voltage devices.

In addition, in one embodiment, the resistor Rs of the current regulator circuit 4022 may be a component external to an integrated circuit, such that the target of the light emitting device current ILED can be set externally.

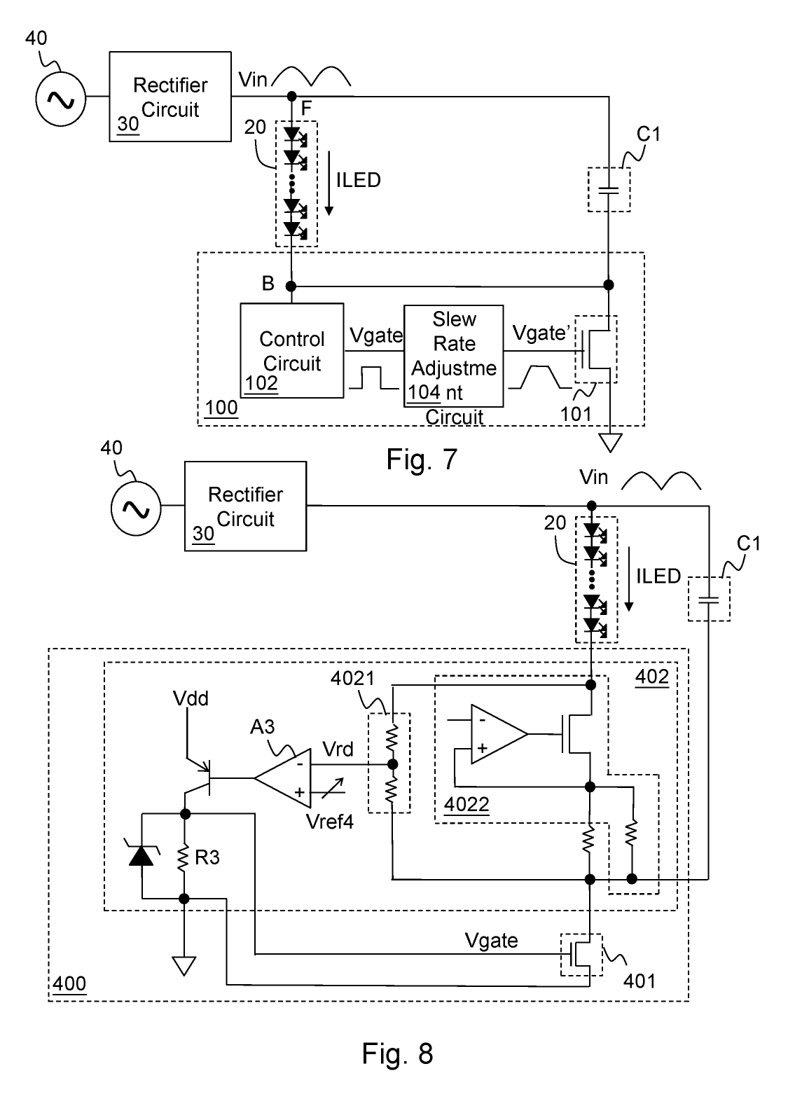

FIG. 7 shows a sixth embodiment of the present invention. In this embodiment, the light emitting device driver circuit 100 according to the present invention further includes a slew rate adjustment circuit 104, which is coupled to the power switch 101 and the control circuit 102, for receiving the operation signal Vgate, and adjusting a slew rate of the operation signal Vgate, to generate a slew rate adjusted operation signal Vgate′ for operating the power switch 101, wherein the operation signal Vgate and the slew rate adjusted operation signal Vgate′ are indicated by small waveforms shown in the figure. One of the functions of the slew rate adjustment circuit 104 is to mitigate the electromagnetic interference (EMI) effect resulting from the sudden level change of the operation signal Vgate which causes a large transient current change. The slew rate adjustment circuit 104 generates the slew rate adjusted operation signal Vgate′ to operate the power switch 101 with a lower slew rate, to thereby mitigate the EMI effect.

FIG. 8 shows a seventh embodiment of the present invention, which shows another embodiment of the light emitting device driver circuit 400 according to the present invention. This embodiment is different from the fifth embodiment in that, in this embodiment, the power switch 401 is connected below the current regulator circuit 4022, and therefore it is not required to be a high voltage device. However, because the operation voltage levels of the power switch 401 and the control circuit 402 may be different from each other, this embodiment provides a bipolar junction transistor (BJT) to amplify a current flowing through a resistor R3, so as to generate the operation signal Vgate having a sufficiently high level to drive the power switch 401. An internal voltage supply Vdd supplies electrical power to the BJT; the internal voltage supply Vdd may be coupled to the rectified input voltage Vin or any power source which is capable of supplying electrical power. This embodiment indicates that, when the voltage level for operating the power switch 401 is different from the voltage level for operating the control circuit 402, the required level of the operation signal Vgate can be generated by amplifying a current flowing through a resistor. When the power switch 401 and the control circuit 402 operate by different voltage levels, in one embodiment, the power switch 401 and the control circuit 402 can be manufactured in two different chips but integrated in a multi-chip module (MCM).

Note that the circuit components which are shown in FIG. 8 but are not explained in detail, are components which are preferred but not necessarily required.

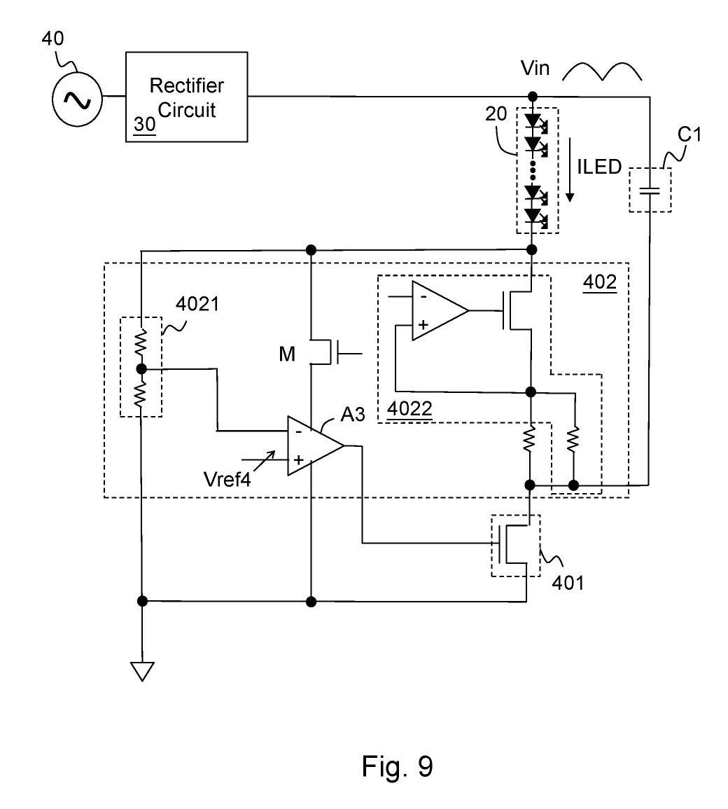

FIG. 9 shows an eighth embodiment of the present invention, which shows another embodiment of the light emitting device driver circuit 400 according to the present invention. This embodiment is similar to the seventh embodiment in that, the power switch 401 is also connected below the current regulator circuit 4022, but this embodiment is different from the seventh embodiment in that, the comparison circuit A3 receives its positive operation power source from the reverse terminal B, and therefore the output terminal of the comparison circuit A3 can generate the operation signal Vgate with a sufficiently high level to drive the power switch 101 (although not shown for other circuits in the figure, all circuits require positive and negative operation power sources, wherein the negative operation power source may be an absolute or relative ground level, and the positive operation power source is a positive voltage). Preferably, a MOS device M is provided between the positive operation power source of the comparison circuit A3 and the reverse terminal B, for protecting the comparison circuit A3.

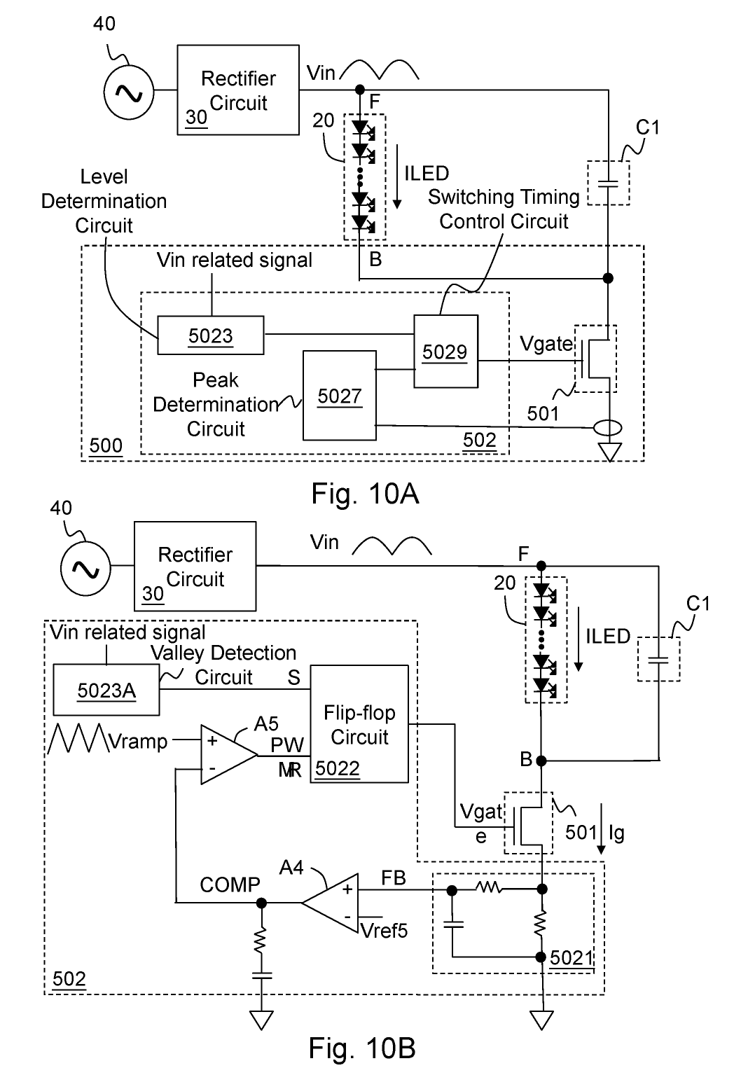

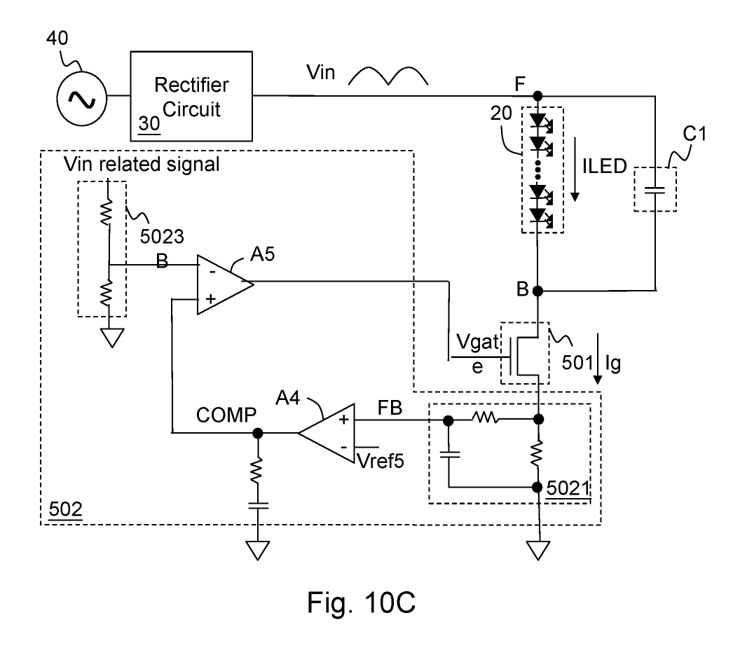

FIG. 10A shows a ninth embodiment of the present invention. This embodiment shows a light emitting device driver circuit 500 according to the present invention. As shown in FIG. 10A, the light emitting device driver circuit 500 drives the LED circuit 20 according to the rectified input voltage Vin, wherein the LED circuit 20 has one or plural LEDs connected in series, and the LED circuit 20 has a forward terminal F and a reverse terminal B. When a voltage between the forward terminal F and the reverse terminal B is not lower than a forward voltage Vf, the LED circuit 20 is conductive.

The light emitting device driver circuit 500 includes a power switch 501 and a control circuit 502. The power switch 501 is coupled to the LED circuit 20 and the output capacitor C1, and operates according to the operation signal Vgate. When the power switch 501 is conductive and the original rectified input voltage Vin is higher than the voltage across the output capacitor C1, the output capacitor C1 is charged and a light emitting device current ILED is provided to the LED circuit 20, and, preferably but not necessarily, when the power switch 501 is not conductive, or when the power switch 501 is conductive and the original rectified input voltage Vin is lower than the voltage across the output capacitor C1, the output capacitor C1 discharges, to provide the light emitting device current ILED to the LED circuit 20, so as to increase the power utilization efficiency.

The control circuit 502 is coupled to the power switch 501, and includes: a level determination circuit 5023, a peak determination circuit 5027, and a switching timing control circuit 5029. The level determination circuit 5023 senses a level of the rectified input voltage according to the rectified input voltage Vin or its related signal. The peak determination circuit 5027 receives a sense result of sensing the light emitting device current ILED, and determines a peak value of the light emitting device current ILED. The switching timing control circuit 5029 is coupled to the level determination circuit 5023 and the peak determination circuit 5027, for determining a timing of turning ON the power switch 501 according to an output of the level determination circuit 5023, and determining a timing of turning OFF the power switch 501 according to an output of the peak determination circuit 5027. The “rectified input voltage Vin or its related signal” may be obtained from the reverse terminal B, or it can be the rectified input voltage Vin itself or its divided voltage (will be described in detail later).

FIG. 10B shows a more specific embodiment of the embodiment shown in FIG. 10A. The control circuit 502 includes a current sense circuit 5021, a comparison circuit A4 (for example an error amplifier in this embodiment), a comparison circuit A5 (for example a comparator in this embodiment), a flip-flop circuit 5022, and a valley detection circuit 5023A (corresponding to the aforementioned level determination circuit 5023). The current sense circuit 5021 is coupled to the power switch 501, for generating a feedback signal FB according to a switch current Ig flowing through the power switch 501. The comparison circuit A4 is coupled to the current sense circuit 5021, for generating a comparison signal COMP according to the feedback signal FB and a reference signal Vref5. The comparison circuit A5 is coupled to the comparison circuit A4, for generating a pulse width modulation signal PWM according to the comparison signal COMP and a ramp signal Vramp; the pulse width modulation signal PWM is provided as the reset signal R of the flip-flop circuit 5022 (the comparison circuits A4 and A5 correspond to the aforementioned peak determination circuit 5027). The valley detection circuit 5023A detects the valley of the rectified input voltage Vin to generate the setting signal S which is inputted to the flip-flop circuit 5022. The flip-flop circuit 5022 is coupled to the comparison circuit A5 and the valley detection circuit 5023A, for generating the operation signal Vgate according to the pulse width modulation signal PWM and the setting signal S (the flip-flop circuit 5022 corresponds to the aforementioned switching timing control circuit 5029).

In this embodiment, the timing of turning ON the power switch 501 is related to the valley of rectified input voltage Vin. Referring to FIG. 2B, a current is provided to the LED circuit 20 consistently because of the operation of the output capacitor C1. Therefore, to achieve a better power utilization efficiency, it is only required to turn OFF the power switch 501 when the voltage of the forward terminal F is not lower than the sum of the forward voltage Vf plus the reference voltage Vref3, while the time point to start turning ON the power switch 501 does not need to be very precise; as such, the valley detection does not need to be very precise either, so the valley detection may be determined by the voltage of the reverse terminal B. Certainly, the valley detection may be determined according to the rectified input voltage Vin itself or its related signal if a better accuracy is desired. In addition, by properly setting the peak value which is to be determined by the peak determination circuit 5027 shown in FIG. 10A, i.e., by properly setting the reference voltage Vref5 or the ramp signal Vramp shown in FIG. 10B, the power switch 501 can be turned OFF at a proper timing to achieve the result shown in FIG. 2B. Note that in this embodiment, even when the “Vin related signal” (FIGS. 10A and 10B) is the rectified input voltage Vin itself or its divided voltage, the major circuits which constitute the integrated circuit (the major circuits including the comparison circuits and the flip-flop circuit 5022, etc.) still do not need to receive the high voltage directly, and therefore these circuits can be made of low voltage transistor devices instead of high voltage transistor devices which capable of withstanding high voltage, so the present invention is still advantageous over the prior art.

FIG. 10C shows another more specific embodiment of the embodiment shown in FIG. 10A. The control circuit 502 includes: the current sense circuit 5021, the comparison circuit A4 (an error amplifier in this embodiment), the comparison circuit A5 (a comparator in this embodiment), and a voltage divider circuit 5023B, but without the flip-flop circuit 5022 and the valley detection circuit 5023A in the previous embodiment. The voltage divider circuit 5023B may include two or more resistive devices connected in series, for example but not limited to two resistors.

The voltage divider circuit 5023B corresponds to the aforementioned level determination circuit 5023, for obtaining a divided voltage of the rectified input voltage Vin or its related signal, i.e., the voltage divider circuit 5023B senses a level of the rectified input voltage Vin or its related signal. The current sense circuit 5021 is coupled to the power switch 501, for generating the feedback signal FB according to the switch current Ig flowing through the power switch 501. The comparison circuit A4 is coupled to the current sense circuit 5021, for generating the comparison signal COMP according to the feedback signal FB and the reference voltage Vref5 (the comparison circuit A4 corresponds to the peak determination circuit 5027). The comparison circuit A5 is coupled to the comparison circuit A4, for generating the operation signal Vgate according to the comparison signal COMP and a divided voltage signal generated by the voltage divider circuit 5023B (the comparison circuit A5 corresponds to the aforementioned switching timing control circuit 5029).

In this embodiment, similarly, the “Vin related signal” (FIG. 10C) may be obtained from the voltage of the reverse terminal B, but certainly it also can be obtained from the rectified input voltage Vin itself or its related signal. And, when the “Vin related signal” is the rectified input voltage Vin itself or its divided voltage, the major circuits which constitute the integrated circuit (the major circuits including the comparison circuits A4 and A5 etc.) still do not need to receive the high voltage directly, and therefore these circuits can be made of low voltage transistor devices instead of high voltage transistor devices which capable of withstanding high voltage, so the present invention is still advantageous over the prior art.

Note that in all the embodiments besides the embodiment shown in FIG. 6, the power switches 101, 401, and 501 can include, for example but not limited to, a vertical double diffused metal oxide semiconductor (VDMOS) device, which is relatively easier to be integrated with the control circuit in one package.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a device or circuit which does not substantially influence the primary function of a signal can be inserted between any two devices or circuits in the shown embodiments, so the term “couple” should include direct and indirect connections. For another example, the light emitting device that is applicable to the present invention is not limited to the LED as shown and described in the embodiments above, but may be any light emitting device with a forward terminal and a reverse terminal. For another example, a PMOS device shown in the embodiments may be replaced by an NMOS device, and an NMOS device shown in the embodiments may be replaced by a PMOS device, with corresponding amendments to the circuit and the signals. For another example, a circuit shows as an example of an embodiment can be adopted in another embodiment; for example, the phase sense circuit can be adopted in the embodiment shown in FIG. 6; or the slew rate adjustment circuit shown in FIG. 7 may be adopted in other embodiments (for example but not limited to the embodiment shown in FIGS. 10A-10B). In view of the foregoing, the spirit of the present invention should cover all such and other modifications and variations, which should be interpreted to fall within the scope of the following claims and their equivalents.

What is claimed is:

1. A light emitting device driver circuit configured to operably drive a light emitting device circuit which is operative according to a rectified input voltage, wherein the light emitting device circuit includes one light emitting device or a plurality of light emitting devices connected in series, wherein the light emitting device circuit has a forward terminal and a reverse terminal, and when a voltage between the forward terminal and the reverse terminal is not lower than a forward voltage, the light emitting device circuit is conductive, the light emitting device driver circuit comprising:
a power switch, coupled to the light emitting device circuit and configured to be coupled to a first output capacitor, the power switch being configured to operate according to an operation signal, wherein the rectified input voltage has an original voltage level when the first output capacitor is not installed, and the rectified input voltage is adjusted to an adjusted voltage level when the first output capacitor is installed; and
a control circuit, which is coupled to the reverse terminal and the power switch, and configured to operably determine whether or not the rectified input voltage is lower than a sum of the forward voltage plus a reference voltage according to a voltage of the reverse terminal, to generate the operation signal for keeping the power switch conductive when the rectified input voltage is lower than the sum;
wherein when the power switch is conductive and the original voltage level is higher than a voltage across the first output capacitor, the first output capacitor is charged and a light emitting device current is provided to the light emitting device circuit.

2. The driver circuit of claim 1, wherein when the power switch is not conductive, or when the power switch is conductive but the original voltage level is lower than the voltage across the first output capacitor, the first output capacitor discharges to provide the light emitting device current to the light emitting device circuit.

3. The driver circuit of claim 1, wherein the power switch is kept conductive in a period wherein the original voltage level is lower than the forward voltage.

4. The driver circuit of claim 1, wherein the forward terminal receives the rectified input voltage, and the control circuit includes:
a current regulator circuit, which is coupled to the reverse terminal, and configured to operably regulate the light emitting device current; and
a first comparison circuit, which is configured to operably generate the operation signal according to the reference voltage and a signal related to the voltage of the reverse terminal.

5. The driver circuit of claim 4, wherein the signal related to the voltage of the reverse terminal is a divided voltage of the voltage of the reverse terminal.

6. The driver circuit of claim 4, wherein the current regulator circuit includes:
a current sense circuit, which is coupled to the reverse terminal, and configured to operably generate a current sense signal according to the light emitting device current;
a divider circuit, configured to generate the signal related to the voltage of the reverse terminal; and
a second comparison circuit, which is coupled to the current sense circuit and the divider circuit, wherein the second comparison circuit is configured to operably generate a regulation voltage for regulating the light emitting device current according to the current sense signal and the signal related to the voltage of the reverse terminal.

7. The driver circuit of claim 6, further comprising a capacitor circuit, which is coupled to an output terminal of the second comparison circuit, and configured to operably filter the regulation voltage.

8. The driver circuit of claim 4, further comprising a timer control circuit, wherein the power switch is conductive for two separate time periods including a first and a second conductive time periods in each period of the rectified input voltage, and the timer control circuit is configured to operably control the second conductive time period of the power switch according to the first conductive time period.

9. The driver circuit of claim 8, wherein the forward terminal is configured to be coupled to a second output capacitor for improving a power factor of the light emitting device current, and the timer control circuit includes:
a delay circuit, which is coupled to the output terminal of the first comparison circuit, and configured to operably delay a predetermined period according to the operation signal, to generate a setting signal;
a flip-flop circuit, which is coupled to the delay circuit, and configured to operably generate a switch control signal according to the setting signal and the operation signal; and
an overriding switch, which is coupled to the output terminal of the flip-flop circuit and an input terminal of the first comparison circuit, and configured to operably generate an overriding signal according to the switch control signal, to adjust a voltage of the input terminal of the first comparison circuit, for controlling the second conductive time period of the power switch in the period of the rectified input voltage.

10. The driver circuit of claim 1, wherein the control circuit includes a phase sense circuit, which is coupled to the reverse terminal, and configured to operably sense a phase angle of the rectified input voltage, for controlling the conductive time of the power switch.

11. The driver circuit of claim 1, wherein the power switch is coupled between the rectified input voltage and the forward terminal to receive the rectified input voltage, and the control circuit includes:
a current regulator circuit, which is coupled to the reverse terminal, and configured to operably regulate the light emitting device current;
a voltage divider circuit, which is connected to the rectified input voltage, and configured to operably generate a divided voltage as the operation signal; and
a third comparison circuit, which is coupled to the reverse terminal and the divider circuit, and configured to operably control the divided voltage of the voltage divider circuit according to the voltage of the reverse terminal.

12. The driver circuit of claim 4, wherein the power switch is coupled between the current regulator circuit and aground level, and an output of the first comparison circuit controls a bipolar junction transistor (BJT) to generate a current flowing through a resistor, and the operation signal is generated according to a voltage across the resistor.

13. The driver circuit of claim 4, wherein the power switch is coupled between the current regulator circuit and aground level, and the first comparison circuit receives a positive operation power source from the reverse terminal.

14. The driver circuit of claim 13, further comprising a MOS device, which is coupled between the positive operation power source of the first comparison circuit and the reverse terminal.

15. The driver circuit of claim 1, wherein the control circuit includes:
a level determination circuit, which is configured to operably sense a level of the rectified input voltage;
a peak determination circuit, which is configured to operably receive a sense result of sensing the light emitting device current, to determine a peak value of the light emitting device current; and
a switching timing control circuit, which is coupled to the level determination circuit and the peak determination circuit, and configured to operably determine a timing point of turning ON the power switch according to an output of the level determination circuit, and determine a timing point of turning OFF the power switch according to an output of the peak determination circuit.

16. The driver circuit of claim 15, wherein the level determination circuit includes a valley detection circuit, configured to operably detect a valley of the rectified input voltage.

17. The driver circuit of claim 15, wherein the level determination circuit includes a voltage divider circuit, configured to operably obtain a divided voltage of the rectified input voltage or a divided voltage of a signal related to the rectified input voltage.

18. The driver circuit of claim 1, further comprising a slew rate adjustment circuit, which is coupled to the power switch, and configured to operably receive the operation signal and adjust a slew rate of the operation signal, to generate a slew rate adjusted operation signal having a slower slew rate than the operation signal, for operating the power switch.

19. The driver circuit of claim 1, wherein the power switch includes a vertical double diffused metal oxide semiconductor (VDMOS) device.

20. A light emitting device driver circuit configured to operably drive a light emitting device circuit which is operative according to a rectified input voltage, wherein the light emitting device circuit includes one light emitting device or a plurality of light emitting devices connected in series, wherein the light emitting device circuit has a forward terminal and a reverse terminal, and when a voltage between the forward terminal and the reverse terminal is not lower than a forward voltage, the light emitting device circuit is conductive, the light emitting device driver circuit comprising:
a power switch, coupled to the light emitting device circuit and configured to be coupled to an output capacitor, the power switch being configured to operate according to an operation signal, to charge the output capacitor during at least a part of a time period wherein the power switch is conductive, and to conduct a light emitting device current flowing through the light emitting device circuit and the power switch when a voltage between the forward terminal and the reverse terminal is not lower than the forward voltage; and
a control circuit, which is coupled to the power switch, and includes:
a level determination circuit, which is configured to operably sense a level of the rectified input voltage;
a peak determination circuit, which is configured to operably receive a sense result of sensing the light emitting device current, and determine a peak value of the light emitting device current; and
a switching timing control circuit, which is coupled to the level determination circuit and the peak determination circuit, and configured to operably determine a timing point of turning ON the power switch according to an output of the level determination circuit, and determine a timing point of turning OFF the power switch according to an output of the peak determination circuit;
wherein transistor devices of the peak determination circuit and the switching timing control circuit are low voltage devices which operate between a high operation voltage and a low operation voltage, and a difference between the high operation voltage and the low operation voltage is equal to or smaller than one half of a highest voltage at the forward terminal.

21. The driver circuit of claim 20, wherein the peak determination circuit includes:
a current sense circuit, which is coupled to the power switch, and configured to operably generate a sense signal according to a switch current flowing through the power switch; and
a comparison circuit, which is coupled to the current sense circuit, and configured to operably generate a comparison signal according to the sense signal and a reference signal.

22. The driver circuit of claim 20, wherein the level determination circuit includes a valley detection circuit, configured to operably detect a valley of the rectified input voltage.

23. The driver circuit of claim 20, wherein the level determination circuit includes a voltage divider circuit, configured to operably obtain a divided voltage of the rectified input voltage or a divided voltage of a signal related to the rectified input voltage.

24. The driver circuit of claim 20, further comprising a slew rate adjustment circuit, which is coupled to the power switch, and configured to operably receive the operation signal and adjust a slew rate of the operation signal, to generate a slew rate adjusted operation signal having a slower slew rate than the operation signal, for operating the power switch.

25. The driver circuit of claim 20, wherein the power switch includes a vertical double diffused metal oxide semiconductor (VDMOS) device.

26. A driving method of a light emitting device circuit, wherein the light emitting device circuit includes one light emitting device or a plurality of light emitting devices connected in series, wherein the light emitting device circuit has a forward terminal and a reverse terminal, and when a voltage between the forward terminal and the reverse terminal is not lower than a forward voltage, the light emitting device circuit is conductive, the driving method comprising:
receiving a rectified input voltage;
controlling a power switch according to an operation signal, such that during at least a part of a time period wherein the power switch is conductive, an output capacitor is charged, and alight emitting device current flows through the light emitting device circuit and the power switch when a voltage between the forward terminal and the reverse terminal is not lower than the forward voltage, and when the power switch is not conductive, the output capacitor discharges to provide the light emitting device current to the light emitting device circuit; and
determining whether or not the rectified input voltage is lower than a sum of the forward voltage plus a reference voltage according to a voltage of the reverse terminal, and generating the operation signal accordingly, for keeping the power switch conductive when the rectified input voltage is lower than the sum, and keeping the power switch not conductive when the rectified input voltage is higher than the sum.

27. A driving method of a light emitting device circuit, wherein the light emitting device circuit includes one light emitting device or a plurality of light emitting devices connected in series, wherein the light emitting device circuit has a forward terminal and a reverse terminal, and when a voltage between the forward terminal and the reverse terminal is not lower than a forward voltage, the light emitting device circuit is conductive, the driving method comprising:
providing a rectified input voltage to the forward terminal;
controlling a power switch according to an operation signal, such that during at least a part of a time period wherein the power switch is conductive, an output capacitor is charged, and alight emitting device current flows through the light emitting device circuit and the power switch when a voltage between the forward terminal and the reverse terminal is not lower than the forward voltage, and when the power switch is not conductive, the output capacitor discharges to provide the light emitting device current to the light emitting device circuit;
sensing a level of the rectified input voltage;
sensing the light emitting device current;
determining a peak value of the light emitting device current; and
determining a timing point of turning ON the power switch according to the level of the rectified input voltage, and determining a timing point of turning OFF the power switch according to peak value of the light emitting device current;
wherein the steps of: sensing the light emitting device current; receiving a sense result of sensing the light emitting device current, and determining a peak value of the light emitting device current; and determining a timing point of turning ON the power switch according to the level of the rectified input voltage, and determining a timing point of turning OFF the power switch according to peak value of the light emitting device current, are achieved by circuits whose transistor devices are made of low voltage devices which operate between a high operation voltage and a low operation voltage, and a difference between the high operation voltage and the low operation voltage is equal to or smaller than one half of a highest voltage at the forward terminal.

28. The driving method of claim 27, wherein the step of sensing a level of the rectified input voltage includes:
detecting a valley of the rectified input voltage, or
obtaining a divided voltage of the rectified input voltage or a divided voltage of a signal related to the rectified input voltage.
